(19) United States
(12) Patent Application Publication
(10) Pub. No.: US 2003/0179086 A1
(43) Pub. Date: Sep. 25, 2003

(54) System for remote tire pressure monitoring with low frequency initiation antenna

(75) Inventors: John S. Nantz, Brighton, MI (US); Riad Ghabra, Dearborn Heights, MI (US); Qingfeng Tang, Novi, MI (US)

Correspondence Address: BROOKS & KUSHMAN P.C. / LEAR CORPORATION, 1000 TOWN CENTER TWENTY-SECOND FLOOR, SOUTHFIELD, MI, 48075, US

(73) Assignee: LEAR CORPORATION, Southfield, MI (US)

(21) Appl. No.: 10/327,318

(22) Filed: Dec. 20, 2002

Related U.S. Application Data
(60) Provisional application No. 60/367,191, filed on Mar. 25, 2002.

(51) Int. Cl. B60C 23/00

(52) U.S. Cl. 340/445

(57) ABSTRACT

A system for remote monitoring of tire pressure in a vehicle having multiple tires, where each tire has an associated wheel well. The system includes a tire monitor mounted in one of the tires that includes a transmitter for transmitting a signal representative of a sensed tire pressure, and a receiver for receiving an initiation signal. An initiator mounted on-board the vehicle associated with the tire is for use in generating a low frequency initiation signal for receipt by the receiver to cause the transmitter to transmit a tire pressure signal. An antenna in communication with the initiator transmits the low frequency initiation signal. The antenna includes a multi-turn loop on a surface of the wheel well associated with the tire such that the low frequency initiation signal transmitted by the antenna is received by the receiver for any tire position.

### CROSS REFERENCE TO RELATED APPLICATION

This application claims the benefit of U.S. provisional application Serial No. 60/367,191, filed Mar. 25, 2002.

### BACKGROUND OF THE INVENTION

1. Field of the Invention

The present invention relates generally to wireless vehicle tire pressure monitoring and, more particularly, to a system for wireless vehicle tire pressure monitoring using initiators and low frequency antennas.

2. Background

It is known in the automotive industry to provide for wireless monitoring of vehicle tire parameters, particularly tire pressure. In such tire pressure monitoring systems, tire pressure sensors and radio frequency (RF) transmitters are mounted inside each tire, typically adjacent the inflation valve stem. In each tire, the tire pressure sensed by the tire pressure sensor is transmitted by the transmitter to a receiver/controller located on-board the vehicle. The tire pressure information delivered to the receiver/controller by the RF signals from the transmitters is subsequently conveyed to a vehicle operator or occupant, typically in the form of a display.

To recognize the particular tire location (e.g., front left (FL), front right (FR), rear left (RL), rear right (RR)) associated with an RF signal received from a tire transmitter, such tire pressure monitoring systems are programmed in an initialization or sign-up operation. That is, in order to provide a vehicle operator with information specific to each vehicle tire, programming of the tire pressure monitoring system must be undertaken by a technician or vehicle owner so that each RF signal from a tire transmitter will be associated with a particular tire location.

Current tire pressure monitoring systems use a magnetic reed switch in each tire for such programming. More particularly, after the on-board vehicle/controller is placed into a program, initialization, or sign-up mode, the magnetic reed switch in each tire is activated by a technician or vehicle owner using a magnet. Such activation causes the tire transmitter in the tire to transmit a tire pressure signal to the controller on the vehicle. In that regard, each pressure sensor and/or transmitter has a unique identification code associated therewith, which identification code is transmitted with the tire pressure signal. Using such identification codes, and by following a preselected sequence for activating each magnetic reed switch, the controller associates each tire pressure signal with a particular tire location.

Such operation, however, can create problems when tires are subsequently rotated or changed from their initial locations to new locations, or a vehicle tire is replaced. Each time the vehicle tires are rotated or a tire is replaced, initialization or sign-up must be repeated to ensure that the system continues to operate properly by conveying accurate information, including tire location, to the vehicle operator. This initialization requirement makes tire rotation more complex, and increases the possibility of inaccurate operation of the system.

The tire transmitters used in such tire pressure monitoring systems are typically battery powered. As a result, a transmitter has a limited amount of functioning time before its battery must be replaced. To help conserve battery power, the transmitters typically transmit tire pressure information at short, predetermined time intervals when the vehicle is moving. In addition, once the vehicle has been stationary for a predetermined amount of time, the transmitters may transmit tire pressure information at longer predetermined time intervals.

In any event, where two or more tire transmitters associated with a vehicle transmit tire pressure signals or data simultaneously, data collision can result at the vehicle mounted receiver/controller, which can adversely affect proper operation of the tire pressure monitoring system. Such data collision can also result when multiple vehicles equipped with tire pressure monitoring systems are in proximity, and tire transmitters associated with each vehicle simultaneously transmit tire pressure signals or data which may be received at each vehicle mounted receiver/controller.

A remote tire pressure monitoring system using low frequency initiators to trigger or initiate transmission of wireless tire information signals from tire mounted transmitters would enable automatic identification of tire locations without the need for initialization or sign-up operations. The use of such low frequency initiators would also eliminate data collision and increase tire transmitter battery life, as well as provide for recharging of tire transmitter batteries.

Thus, there exists a need for an improved remote tire pressure monitoring system using low frequency initiators and low frequency antennas. Each such antenna would preferably be a multi-turn loop placed in the wheel well of the vehicle proximate to the vehicle tire. Such an antenna would also preferably conform to the surface of the wheel well, whether planar or non-planar, and would have dimensions comparable to those of the wheel well surface. Such an antenna would still further preferably be molded in the material forming the wheel well, or glued as an overlay onto such material. If an overlay, such an antenna would preferably be formed onto a plastic background material.

### DISCLOSURE OF THE INVENTION

Accordingly, the present invention provides an improved system and method for remote vehicle tire pressure monitoring.

According to the present invention, then, a system is provided for remote monitoring of tire pressure in a vehicle having a plurality of tires, each tire having a wheel well associated therewith, each wheel well having a surface. The system comprises a tire monitor for mounting in one of the plurality of tires, the monitor comprising a transmitter for transmitting a signal representative of a sensed tire pressure, and a receiver for receiving an initiation signal. The system also comprises an initiator for mounting on-board the vehicle and to be associated with the one of the plurality of tires. The initiator is for use in generating a low frequency initiation signal for receipt by the receiver to cause the transmitter to transmit a tire pressure signal. The system still further comprises an antenna in communication with the initiator for use in transmitting the low frequency initiation signal. The antenna comprises a multi-turn loop on the surface of the wheel well associated with the one of the plurality of tires such that the low frequency initiation signal transmitted by the antenna is received by the receiver for any tire position.

According to another embodiment of the present invention, a system is provided for remote monitoring of tire pressure in a vehicle having a plurality of tires, each tire having a wheel well associated therewith, each wheel well having a surface. In this embodiment, the system comprises a tire monitor for mounting in one of the plurality of tires. The monitor comprises a transmitter for transmitting a signal representative of a sensed tire pressure, and a receiver for receiving an initiation signal. The system further comprises an initiator for mounting on-board the vehicle and to be associated with the one of the plurality of tires. The initiator is for use in generating a low frequency initiation signal for receipt by the receiver to cause the transmitter to transmit a tire pressure signal. The system still further comprises an antenna in communication with the initiator for use in transmitting the low frequency initiation signal. The antenna comprises a multi-turn loop on the surface of the wheel well associated with the one of the plurality of tires such that the low frequency initiation signal transmitted by the antenna is received by the receiver for any tire position. The surface of the wheel well has an area and a shape, and the multi-turn loop has an area and a shape substantially conforming to the area and shape of the surface of the wheel well

The following detailed description and accompanying drawings set forth preferred embodiments of the present invention.

### BRIEF DESCRIPTION OF THE DRAWINGS

FIG. 1 is a simplified, representative block diagram of an embodiment of a remote tire pressure monitoring system using low frequency initiators, each having a low frequency antenna according to the present invention;

FIG. 2 is a simplified, representative diagram of an embodiment of the low frequency antenna according to the present invention;

FIG. 3 is a simplified, representative diagram of a vehicle wheel well environment for the low frequency antenna according to the present invention; and

FIG. 4 is a simplified, representative diagram of a vehicle wheel well environment depicting an embodiment of the low frequency antenna according to the present invention.

### DETAILED DESCRIPTION OF THE PREFERRED EMBODIMENT(S)

Referring now to the Figures, preferred embodiments of the present invention will now be described in detail. As previously noted, it is known in the automotive industry to provide for wireless monitoring of vehicle tire parameters, particularly tire pressure. In such tire pressure monitoring systems, tire pressure sensors and radio frequency (RF) transmitters are mounted inside each tire, typically adjacent the inflation valve stem. In each tire, the tire pressure sensed by the tire pressure sensor is transmitted by the transmitter to a receiver/controller located on-board the vehicle. The tire pressure information delivered to the receiver/controller by the RF signals from the transmitters is subsequently conveyed to a vehicle operator or occupant, typically in the form of a display.

To recognize the particular tire location (e.g., front left (FL), front right (FR), rear left (RL), rear right (RR)) associated with an RF signal received from a tire transmitter, such tire pressure monitoring systems are programmed in an initialization or sign-up operation. That is, in order to provide a vehicle operator with information specific to each vehicle tire, programming of the tire pressure monitoring system must be undertaken by a technician or vehicle owner so that each RF signal from a tire transmitter will be associated with a particular tire location.

Current tire pressure monitoring systems use a magnetic reed switch in each tire for such programming. More particularly, after the on-board vehicle/controller is placed into a program, initialization, or sign-up mode, the magnetic reed switch in each tire is activated by a technician or vehicle owner using a magnet. Such activation causes the tire transmitter in the tire to transmit a tire pressure signal to the controller on the vehicle. In that regard, each pressure sensor and/or transmitter has a unique identification code associated therewith, which identification code is transmitted with the tire pressure signal. Using such identification codes, and by following a preselected sequence for activating each magnetic reed switch, the controller associates each tire pressure signal with a particular tire location.

As noted previously, however, such operation can create problems when tires are subsequently rotated or changed from their initial locations to new locations, or a vehicle tire is replaced. Each time the vehicle tires are rotated or a tire is replaced, initialization or sign-up must be repeated to ensure that the system continues to operate properly by conveying accurate information, including tire location, to the vehicle operator. This initialization requirement makes tire rotation more complex, and increases the possibility of inaccurate operation of the system.

As also previously noted, the tire transmitters used in such tire pressure monitoring systems are typically battery powered. As a result, a transmitter has a limited amount of functioning time before its battery must be replaced. To help conserve battery power, the transmitters typically transmit tire pressure information at short, predetermined time intervals when the vehicle is moving. In addition, once the vehicle has been stationary for a predetermined amount of time, the transmitters may transmit tire pressure information at longer predetermined time intervals.

In any event, where two or more tire transmitters associated with a vehicle transmit tire pressure signals or data simultaneously, data collision can result at the vehicle mounted receiver/controller, which can adversely affect proper operation of the tire pressure monitoring system. Such data collision can also result when multiple vehicles equipped with tire pressure monitoring systems are in proximity, and tire transmitters associated with each vehicle simultaneously transmit tire pressure signals or data which may be received at each vehicle mounted receiver/controller.

As also noted above, a system and method using low frequency initiators to trigger or initiate transmission of wireless tire information signals from tire mounted transmitters would enable automatic identification of tire locations, without the need for initialization or sign-up operations. The use of such low frequency initiators would also eliminate data collision and increase tire transmitter battery life, as well as provide for recharging of tire transmitter batteries.

Thus, there exists a need for an improved remote tire pressure monitoring system using low frequency initiators and low frequency antennas. Each such antenna would preferably be a multi-turn loop placed in the wheel well of the vehicle proximate to the vehicle tire. Such an antenna would also preferably conform to the surface of the wheel well, whether planar or non-planar, and would have dimensions comparable to those of the wheel well surface. Such an antenna would still further preferably be molded in the material forming the wheel well, or glued as an overlay onto such material. If an overlay, such an antenna would preferably be formed onto a plastic background material.

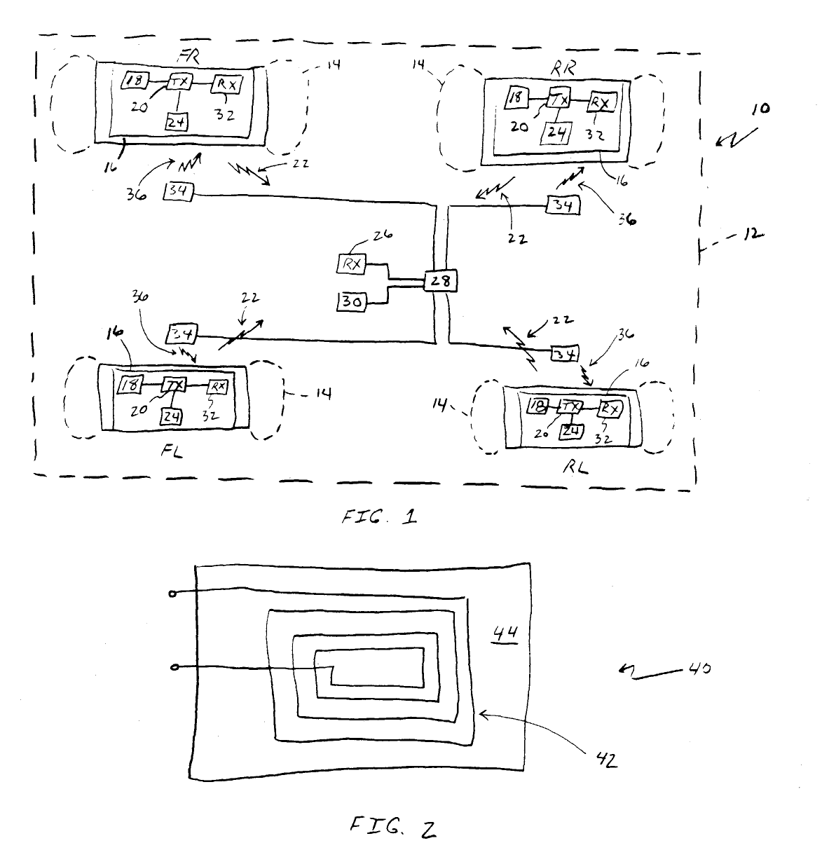

Referring now to FIG. 1, a simplified, representative block diagram of an embodiment of a remote tire pressure monitoring system in which the low frequency antenna according to the present invention may be used is shown, denoted generally by reference numeral 10. As seen therein, the system (10) is designed for use in a vehicle (12) having a plurality of tires (14). Each one of the plurality of tires (14) has a tire location associated therewith, such as front left (FL), front right (FR), rear left (RL), and rear right (RR). It should be noted that while the present invention is described herein for use in an automotive vehicle having four tires, such an environment is exemplary only. That is, the present invention is suitable for use in any type of vehicle having any number of tires.

Still referring to FIG. 1, the system (10) includes a plurality of tire monitors (16). Each tire-monitor (16) is provided for mounting in one of the plurality of tires (14). In that regard, each tire monitor (16) is preferably located inside the tire (14) adjacent the tire inflation valve stem (not shown), although any mounting location known in the art may be used. Each tire monitor (16) includes an appropriate sensor (18) and/or other devices (not shown), for sensing, determining and/or monitoring at least the pressure of the associated tire (14). It should be noted, however, that each tire monitor (16) may also be equipped to sense, determine and/or monitor any number of tire parameters in addition to pressure including, but not limited to, temperature, status (i.e., whether or not the tire is rotating) and/or speed, in any fashion well known to those of ordinary skill in the art.

Each tire monitor (16) also includes a transmitter (20) in communication with sensor (18) for transmitting a tire pressure signal (22) representative of the sensed tire pressure. In that regard, tire pressure signal (22) is preferably a radio frequency (RF) signal, although other signal types known in the art could be employed. It should be noted that transmitter (20) may also transmit, as part of or separate from tire pressure signal (22), a signal or signals representative of information concerning any of a number of other tire parameters such as temperature, status and/or speed as sensed, measured and/or determined by an appropriately equipped tire monitor (16).

Referring still to FIG. 1, the tire pressure monitoring system (10) of the present invention also includes a receiver (26) for mounting on-board the vehicle (12) for receiving the tire pressure signals (22) transmitted by transmitters (20). Receiver (26) comprises one or more antenna (not shown) to be located at one or more selected sites on the vehicle (12). Receiver (26) is provided in communication with a controller (28) mounted on-board vehicle (12). Controller (28) is for processing tire pressure signals (22) received by receiver (26) from transmitters (20) and for generating information signals (not shown) for use in conveying at least tire pressure information to a vehicle operator, typically via a display unit (30), such as an LED display or a lighted icon in the vehicle dashboard or a vehicle console. It should be noted that receiver (26) and controller (28) may be combined in a single module. Once again, as described above, information concerning other tire parameters, such as temperature, status and/or speed may also be conveyed to the vehicle operator. It should be noted that the information may also be conveyed to the vehicle operator in an audible fashion, and may include a warning, which may also be audible, if tire pressure, other tire parameters, such as temperature, are outside recommended ranges.

Referring still to FIG. 1, each pressure sensor (18) and/or transmitter (20) preferably has a unique identification code associated therewith. Such identification codes serve to particularly associate sensors (18) and/or transmitters (20) with vehicle (12). As a result, as described in greater detail below, such identification codes can facilitate confirming or verifying tire location information. Each transmitter (20) also preferably transmits such identification code for receipt by receiver (26) and for use by controller (28) in verifying that the tire pressure signals (22) received by receiver (26) are associated with the vehicle (12). Transmitters (20) may transmit the identification codes as part of tire pressure signal (22), or as a separate signal (not shown).

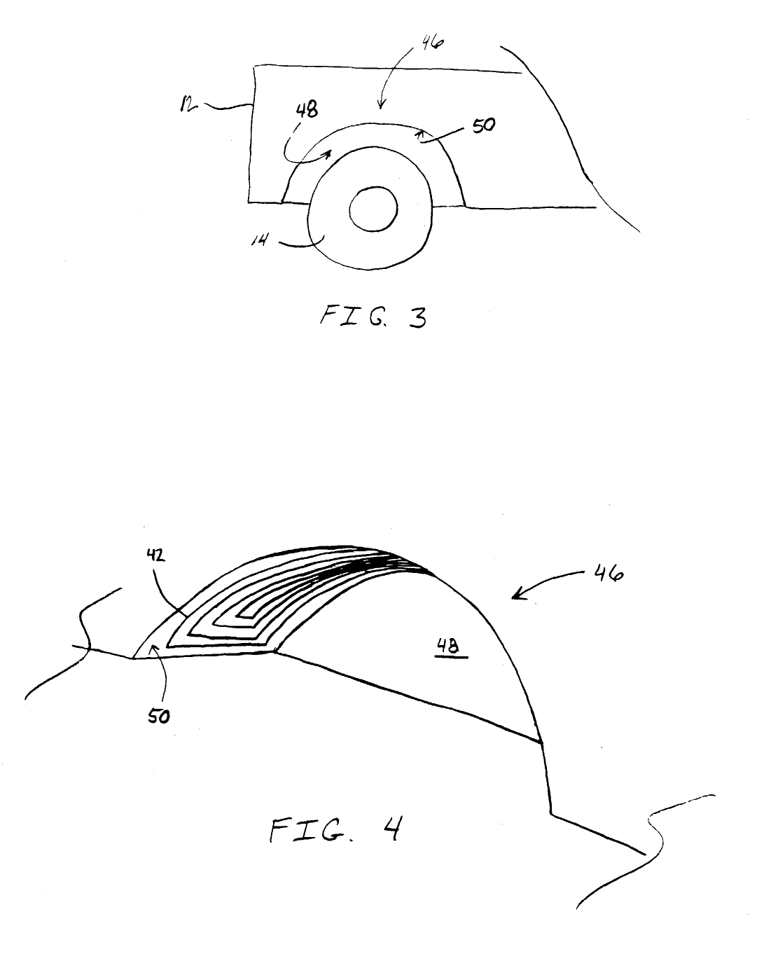

Each tire monitor (16) still further includes a receiver (32), which is provided in communication with transmitter (20). Each tire monitor (16) is also associated with an initiator (34). In that regard, each initiator (34) is mounted on the vehicle, preferably proximate to one of -the tire locations, such as in a vehicle wheel well (see FIG. 3). The plurality of initiators (34) are provided in communication with controller (28). As will be described in greater detail below, in response to control signals (not shown) from controller (28), each initiator (34) generates a transmitter initiation signal (36) for receipt by receiver (32). The transmitter initiation signal (36), in turn, causes the transmitter (20) to transmit a tire pressure signal (22).

According to the system (10) of the present invention, controller (28) preferably generates control signals (not shown) for activating each of the plurality initiators (34) in a preselected or predetermined manner (e.g., sequentially at or after vehicle start-up, such as when the vehicle is placed in any forward or a reverse gear). Such activation causes the initiators (34) to generate a transmitter initiation signal (36). In that regard, it should be noted that each initiator (34) is provided in communication with an antenna (see FIGS. 2 and 3) for use in transmitting an initiation signal (36), and that such an antenna may be located proximate to the associated tire (14) and tire monitor (16).

In turn, an initiation signal (36), received by the associated tire receiver (32), causes the associated transmitter (20) to transmit a tire pressure signal (22). Initiation signals (36) are preferably low frequency (LF) signals in the range of approximately 125-135 kHz, but other types of signals could be used. In that regard, LF initiation signals (36) are used, the LF antennas for initiators (34) may advantageously be shared between the tire pressure monitoring system and a vehicle remote keyless entry system also utilizing LF signals.

More particularly, controller (28) preferably selectively activates each initiator (34) to generate a transmitter initiation signal (36). In that regard, when seeking tire pressure information from the Front Left (FL) tire (14), controller (28) activates the initiator (34) associated with the FL tire location. As a result, in the manner described above, vehicle-mounted receiver (26) receives a tire pressure signal (22) from transmitter (20) in tire monitor (16) associated with tire (14) having the FL location. A similar process is performed for each tire location (e.g., front right (FR), rear right (RR), and rear left (RL)). In such a fashion, controller (28) is automatically programmed and learns tire location information, even after rotation of tires (14) to new locations. Such tire location information can be conveyed by controller (28) to a vehicle occupant via display (30) along with tire pressure information, as well as information concerning other tire parameters, such as temperature, status and/or speed. Once again, any such information may also be conveyed to the vehicle operator in an audible fashion, and may include a warning, which may also be audible, if tire pressure, other tire parameters, such as temperature, are outside recommended ranges.

Controller (28), which preferably takes the form of an appropriately programmed microprocessor or DSP, can be programmed to perform such polling in any fashion. That is, such polling could be undertaken continuously or periodically while the vehicle is in motion, such as may be indicated by a minimum vehicle speed or by equipping tire monitors (16) with rotation sensors (not shown) to detect rotation of tires (14). Such polling could alternatively be undertaken once at every ignition cycle, such as at or immediately after vehicle start-up, and/or when the vehicle (12) is placed in any forward gear or a reverse gear. In any event, such polling by controller (28) also eliminates collision between the tire pressure signals (22) and the data contained therein (22) transmitted from transmitters (20), thereby facilitating receipt of each tire pressure signal (22) by receiver (26). Such polling also helps to eliminate data collision between tire pressure signals from multiple vehicles in proximity to one another, each equipped with tire pressure monitoring systems.

As previously described, each pressure sensor (18) and/or transmitter (20) has a unique identification code associated therewith, which identification code may be transmitted with the tire pressure signal (22). As a result, after selectively activating transmitters (20) in the fashion described above, controller (28) can associate each unique identification code with a particular tire location (e.g., front left (FL), front right (FR), rear left (RL), rear right (RR). Thereafter, controller (28) can verify a tire location associated with any tire pressure signal (22) received by confirming that the tire pressure signal (22) received has the identification code expected. Such verification could be done at any time, such as at vehicle start-up, when the vehicle is placed in a forward or a reverse gear, or periodically when the vehicle (12) is in motion, such as again may be indicated by a minimum vehicle speed or by equipping tire monitors (16) with rotation sensors (not shown) to detect rotation of tires (14).

It should be noted that transmitters (20) are preferably configured to transmit tire pressure signals (22) only in response to activation by initiators (34). Alternatively, transmitters (20) may transmit tire pressure signals (22) independently, according to any desired schedule. In that regard, initiation signals (36) from initiators (34) may included instructions for use in controlling transmission of tire pressure signals (22) by the associated transmitter (20). For example, instructions in initiation signals (36) may control transmitters (20) to transmit tire pressure signals (22) according to a predetermined time period or schedule, thereby helping conserving power of batteries (24). Instructions in initiation signals (36) may also control transmitters (20) to transmit tire pressure signals (22) based on vehicle speed, such as more often at higher vehicle speeds, based on road condition, such as more often for uneven or bumpy roads as may be determined by impact sensors (not shown) in tire monitors (16) , or based on other vehicle parameter. Regardless, in the fashion described above, controller (24) can correctly identify a tire location associated with any tire pressure signal (20) received even where transmitters (18) transmit tire pressure signals (20) independently (i.e., without the need for activation by initiators (34)).

Referring still to FIG. 1, each tire monitor (16) also includes a battery (24) in communication with and for providing power to an associated transmitter (20.) Transmitter (20) may also transmit, again as part of or separate from tire pressure signal (22), a signal or signals representative of the status of such a battery (24), including a low battery power status, for receipt by receiver (26). In that regard, such a low battery power status signal may be transmitted by transmitter (20) when the power of the associated battery (24) falls below a predetermined threshold value. In response to the receipt by receiver (26) of such a low battery power status signal, controller (28) preferably activates the associated initiator (34) to generate a low frequency electromagnetic field (not shown). Such an electromagnetic field is for use in recharging the battery (24) in the associated tire pressure monitor (16). In such a fashion, the present invention eliminates or substantially reduces the need to replace batteries (24) in tire pressure monitors (16).

Referring next to FIG. 2, a simplified, representative diagram of an embodiment of a low frequency antenna for according to the present invention is shown, denoted generally by reference numeral 40. As seen in FIG. 2, antenna (40) preferably comprises a multi-turn loop (42). Multi-turn loop (42) may be formed in any fashion known in the art on a non-metallic background material (44), which is preferably a plastic or mylar material, although other materials could be used. With reference to FIGS. 3 and 4, multi-turn loop (42) is to be located in a vehicle wheel well (46) proximate to the associated vehicle tire (14).

More particularly, referring now to FIG. 3, a simplified, representative diagram of a wheel well for vehicle (12) is shown, denoted generally by reference numeral 46. As seen therein, wheel well (46) may have a number of surfaces, such as a substantially planar back surface (48) located generally behind tire (14), and a non-planar upper surface (50) located generally above tire (14). Non-planar upper surface (50) may be substantially semi-cylindrical in shape.

FIG. 4 is a simplified, representative diagram of a vehicle wheel well environment depicting an embodiment of the low frequency antenna according to the present invention. As seen therein, and with continuing reference to FIG. 3, multi-turn loop (42) may be located on any surface (48, 50) in wheel well (46), and preferably conforms to the surface (48, 50) on which it is located. That is, where multi-turn loop (42) is located on generally planar back surface (48), multi-turn loop (42) has a substantially planar shape. Similarly, as seen in FIG. 4, where multi-turn loop (42) is located on upper surface (50), multi-turn loop (42) has a generally conforming shape, which may be substantially semi-cylindrical.

Referring still to FIGS. 3 and 4, multi-turn loop (42) also preferably has an area that is comparable to the area of the surface (48, 50) in wheel well (46) on which it is located. For example, where a surface (48, 50) on which multi-turn loop (42) is located has first and second dimensions, multi-turn loop (42) preferably has similar first and second dimensions. Moreover, where a surface (48, 50) in wheel well (46) on which multi-turn loop (42) is to be located is a molded material, such as a plastic, multi-turn loop (42) is preferably molded into that material of surface (48, 50) in any fashion known in the art, such as by overmolding. In that regard, then, as used herein, references to multi-turn loop (42) located on a surface (48, 50) include molded into such a surface (48, 50). Alternatively, as shown and described above in connection with FIG. 2, multi-turn loop (42) may be formed on a background material (44). In that event, multi-turn loop (42) may be adhered or attached as an overlay to a surface (48, 50) of wheel well (46) in any fashion known in the art, such as through the use of a glue.

From the foregoing description, it can be seen that the present invention provides an improved remote tire pressure monitoring system using low frequency initiators and low frequency antennas. The low frequency initiators trigger or initiate transmission of wireless tire information signals from tire mounted transmitters to enable automatic identification of tire locations without the need for initialization or sign-up operations, eliminate data collision, increase tire transmitter battery life, and provide for recharging of tire transmitter batteries. Each low frequency antenna is preferably a multi-turn loop placed in the wheel well of the vehicle proximate to the vehicle tire. The antenna preferably conforms to the surface of the wheel well, whether planar or non-planar, and has dimensions comparable to those of the wheel well surface. The antenna is still further preferably molded in the material forming the wheel well, or glued as an overlay onto such material. As an overlay, the antenna is preferably formed onto a plastic background material. In such a fashion, an initiation signal transmitted from the antenna is received by a tire mounted receiver in any tire position, thereby ensuring transmission of a tire pressure signal from a tire mounted transmitter.

While various embodiments of the invention have been illustrated and described, it is not intended that these embodiments illustrate and describe all possible forms of the present invention. Rather, the words used in the specification are words of description rather than limitation, and it is understood that various changes may be made without departing from the spirit and scope of the invention. Indeed, many alternatives, modifications, and variations will be apparent to those skilled in the art in light of the foregoing description, and the present invention is intended to embrace all such alternatives,

What is claimed is:

1. A system for remote monitoring of tire pressure in a vehicle having a plurality of tires, each tire having a wheel well associated therewith, each wheel well having a surface, the system comprising:
a tire monitor for mounting in one of the plurality of tires, the monitor comprising a transmitter for transmitting a signal representative of a sensed tire pressure, and a receiver for receiving an initiation signal;
an initiator for mounting on-board the vehicle and to be associated with the one of the plurality of tires, the initiator for use in generating a low frequency initiation signal for receipt by the receiver to cause the transmitter to transmit a tire pressure signal; and
an antenna in communication with the initiator for use in transmitting the low frequency initiation signal, the antenna comprising a multi-turn loop on the surface of the wheel well associated with the one of the plurality of tires such that the low frequency initiation signal transmitted by the antenna is received by the receiver for any tire position.

2. The system of claim 1 wherein the surface of the wheel well comprises a non-metallic material and the multi-turn loop is molded into the nonmetallic material.

3. The system of claim 1 wherein the multi-turn loop is constructed on a non-metallic background material to be adhered to the surface of the wheel well.

4. The system of claim 1 wherein the surface of the wheel well has a shape, and the multi-turn loop has a shape substantially conforming to the shape of the wheel well.

5. The system of claim 4 wherein the shape of the multi-turn loop is substantially planar.

6. The system of claim 4 wherein the shape of the multi-turn loop is non-planar.

7. The system of claim 1 wherein the surface of the wheel well has an area, and the multi-turn loop has an area comparable to the area of the surface of the wheel well.

8. The system of claim 1 wherein the low frequency initiation signal has a frequency in the range of about 125 to 135 kHz.

9. The system of claim 2 wherein the surface of the wheel well has a shape, and the multi-turn loop has a shape substantially conforming to the shape of the wheel well.

10. The system of claim 9 wherein the shape of the multi-turn loop is substantially planar.

11. The system of claim 9 wherein the shape of the multi-turn loop is non-planar.

12. The system of claim 9 wherein the surface of the wheel well has an area, and the multi-turn loop has an area comparable to the area of the surface of the wheel well.

13. The system of claim 3 wherein the surface of the wheel well has a shape, and the multi-turn loop has a shape substantially conforming to the shape of the wheel well.

14. The system of claim 13 wherein the shape of the multi-turn loop is substantially planar.

15. The system of claim 13 wherein the shape of the multi-turn loop is non-planar.

16. The system of claim 13 wherein the surface of the wheel well has an area, and the multi-turn loop has an area comparable to the area of the surface of the wheel well.

17. A system for remote monitoring of tire pressure in a vehicle having a plurality of tires, each tire having a wheel well associated therewith, each wheel well having a surface, the system comprising:
a tire monitor for mounting in one of the plurality of tires, the monitor comprising a transmitter for transmitting a signal representative of a sensed tire pressure, and a receiver for receiving an initiation signal;
an initiator for mounting on-board the vehicle and to be associated with the one of the plurality of tires, the initiator for use in generating a low frequency initiation signal for receipt by the receiver to cause the transmitter to transmit a tire pressure signal; and
an antenna in communication with the initiator for use in transmitting the low frequency initiation signal, the antenna comprising a multi-turn loop on the surface of the wheel well associated with the one of the plurality of tires such that the low frequency initiation signal transmitted by the antenna is received by the receiver for any tire position, wherein the surface of the wheel well has an area and a shape, and the multi-turn loop has an area and a shape similar to the area and shape of the surface of the wheel well.

18. The system of claim 17 wherein the shape of the multi-turn loop is substantially planar.

19. The system of claim 17 wherein the shape of the multi-turn loop is non-planar.

20. The system of claim 17 wherein the low frequency initiation signal has a frequency of in the range of about 125 to 135 kHz.
